(19) United States
(12) Patent Application Publication
(10) Pub. No.: US 2026/0196955 A1
(43) Pub. Date: Jul. 9, 2026

(54) AC CONTROL SYSTEM, APPARATUS AND METHODS, FOR EXAMPLE FOR USE WITH ELECTRONIC MACHINES

(71) Applicant: EXRO TECHNOLOGIES INC., Calgary (CA)

(72) Inventors: Eric Hustedt, Calgary (CA); Gabriel Moscardi Pauka, Calgary (CA); Stephen Andrew Weeks, Calgary (CA)

(21) Appl. No.: 19/134,616

(22) PCT Filed: Nov. 24, 2023
(86) PCT No.: PCT/CA2023/051573

§ 371 Date: May 30, 2025

Related U.S. Application Data
(60) Provisional application No. 63/429,048, filed on Nov. 30, 2022.

(51) Int. Cl. H02P 21/22; H02P 21/14; H02P 27/08

(52) U.S. Cl. CPC H02P 21/22; H02P 21/14; H02P 27/08; H02P 2209/05; H02P 2209/11

(57) ABSTRACT

AC control systems, devices and methods which can, for instance drive a power converter coupled to drive electric machines (e.g., electric motors) advantageously employs an AC controller that implements current mode control utilizing an average current controller in conjunction with and an AC peak current controller with high bandwidth. Such can advantageously employ a fixed switching frequency, and utilize a zero vector to generate the same DC link ripple current as would be generated using field orientated control (FOC) with space vector modulation (SVM).

### CROSS-REFERENCE TO RELATED APPLICATION

This patent application claims priority of U.S. Patent Application No. 63/429,048, filed on Nov. 30, 2022, the entire disclosure of which is hereby incorporated by reference herein for all purposes.

### TECHNICAL FIELD

The present disclosure generally relates to alternating current (AC) control systems, apparatus and/or methods, which can, for example, be used to drive electric machines, for instance to drive rotating electric machines (e.g., electric motors).

### BACKGROUND

### Description of the Related Art

Electric machines take a variety of forms, for example rotating electric machines such as electric motors and electric generators, or electric machines that can operate as an electric motor during one period while operating as an electric generator during another period. These rotating electric machines are referred to as such since they typically include a rotor that rotates with respect to a stator.

Most motor drives today, both synchronous and asynchronous, utilize a voltage source inverter (VSI) with Field Oriented Control (FOC) to control the motor currents to reach a desired or specified torque output by an electric motor.

From a fundamental control principle, FOC is a “voltage mode” controller, that is, the regulation target is controlled by setting an output voltage via a duty cycle of a pulse width modulated (PWM) control of the switches of the VSI. In the case of a motor drive, the quantity being regulated is typically a phase current of the electric motor, and the controlled quantity is a voltage applied to the coils of the electric motor. FOC has several limitations due to this, as well as limitations due to the nature of the synchronous reference frame and due to the nature of the electric machines themselves. Some limitations common to voltage mode control systems include: i) lower system response times since any change in the system must be detected as a change in the output before the changes can be corrected by the controller; ii) loop gain varies with input DC voltage; and iii) the dominant pole load (inductor) typically means that the control bandwidth is limited.

Since modern electric machines, especially permanent magnet electric motors, are essentially a low impedance voltage source with a small series inductance, this presents several new challenges.

For example, due to the nature of FOC, the control system is expecting a perfect sinusoidal back electromotive force (EMF) voltage. However, in reality there will be harmonic content in the back EMF voltage. This will manifest as distortions in the phase current due to the difference between back EMF and the applied voltage. Application of a direct-quadrature-zero (DQ0) transform will frequency shift these harmonics, which then manifest as AC content on what should nominally be direct current (DC) quantities (i.e., id and iq), before being presented to proportional integral (PI) regulators. Since the frequency of this harmonic content is dependent on the rotating speed of rotor, the limited bandwidth of the PI controllers quickly prevents these harmonics from successfully being regulated out as the speed of the electric motor increases.

Also for example, the series inductance of the electric machine needs compensation, especially as rotating speed (e.g., motor frequency) increases. This introduces a phase shift between the applied voltage and the back EMF voltage. In DQ terms, this means that as speed increases more “D axis” voltage is required to produce the desired “Q axis” current.

Today these problems are mitigated with electric machine designs that minimize back EMF harmonics and motor controllers which employ complicated control algorithms with several feed forward loops, to varying degrees of success.

Aside from the control challenges, the stiff induced voltage produced by these electric machines means that any system errors can produce large currents, potentially leading to system shut down or even damage to the drive circuitry.

This sensitivity reduces fault tolerance to things like motor angle sensor errors which can result in large voltage difference between an inverter and an electric motor driven via the inverter.

The vast majority of these issues are a result of having to predict what voltage to apply to the electric machine to produce the desired current.

Hysteresis control is another control technique sometimes used in motor control, where the ON and OFF criteria for controlling the switches is determined by a hysteresis band around the controlled quantity. Hysteresis motor controllers avoid many of the downfalls of FOC, but have severe disadvantages, including: 1) the switching frequency is not fixed, both frequency and duty cycle varying with load; 2) only full positive or full negative voltages are applied, resulting in higher phase current ripple and very large ripple current stress on the DC link storage component. While the first issue is manageable, the second issue is a significant disadvantage and far outweighs any advantage of hysteresis control for electric motors.

Improved systems, apparatus and/or methods that address these issues are of course desirable.

### BRIEF SUMMARY

Described herein are systems, apparatus and/or methods that implement a current mode control to control the operation of inverter power electronics. Such can, for example, be used to control operation of rotating electric machines, for instance to control operation of electric motors. Such can also be used with other types of electric machines, for instance generators, or with electric power grids. The current mode control can advantageously employ an AC peak current controller or regulator in conjunction with an average current controller. The current mode control approach can advantageously employ two nested control loops, the AC peak current controller or regulator in an inner control loop, and the average current controller in an outer control loop. The AC peak current controller has a relatively high bandwidth as compared to a relatively low bandwidth of the average current controller. The relatively low bandwidth of the average current controller (e.g., 1 KHz, 1 KHz to 3 KHz) can be sufficiently low that the average current controller does not respond to either the switching frequency (e.g., 10 KHz), for instance set by a pulse width modulated signal, and also does not respond to any harmonics, which tend to have relatively high frequencies since it is the AC peak current controller that responds to such.

The AC peak current controller or regulator controls operation based on a current ramp of an inductor, which is a function of an applied voltage, and therefore will immediately respond to any changes in voltage thereby eliminating delays in response as well as voltage dependent gain variations. As a result, the AC peak current controller or regulator advantageously has a very high bandwidth, approaching the Nyquist limit determined by the switching frequency.

In this approach, average proportional integral (PI) controllers used in the average current controller are commanding an output current rather than a voltage, advantageously reducing the effect of the output inductor and allowing a higher gain bandwidth, as well as providing native pulse-by-pulse current limiting by simply constraining the maximum output of the PI.

The AC peak current controller with high bandwidth relative to a low bandwidth of the average current controller has various advantages over hysteresis control, for example: a fixed switching frequency and utilization of a zero vector to generate a same DC link ripple current as would be generated via FOC with space vector modulation (SVM).

Some implementations can employ an AC peak current controller without an average current controller. Some implementations can control a power converter, for example a power inverter. Some implementations can control an electric machine, for instance rotating electric machine such as an electric motor and, or an electric generator. For instance, an AC peak current controller can control an inverter to supply current to a poly phase electric motor, with or without an average current controller.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram showing a drive circuit coupled to control a power converter which in turn coupled to drive a rotating electric machine, in the form of an electric motor, the inverter coupled to receive power from a power source, wherein the drive circuit includes an alternating current controller including an average current controller, an alternating current (AC) peak current controller, and optionally a gate driver, according to one illustrated implementation.

FIG. 2A is a schematic diagram showing a power converter in the form of a three phase power converter according to one illustrated implementation, which can be electrically coupled and is operable via the AC controller to, for example, supply current to drive a rotating electric machine based on drive signals generated by the AC controller of FIG. 1.

FIG. 2B is a schematic diagram showing a power converter in the form of a half-bridge or single phase power converter according to another illustrated implementation, an integer number n multiple instances of which can be electrically coupled to and is operable via the AC controller to, for example, supply current to drive an n phase rotating electric machine based on drive signals generated by the AC controller of FIG. 1.

FIG. 2C shows a power converter 230 in the form of an H-bridge power stage coupled to an inductor L, according to one illustrated implementation.

FIG. 3 is a schematic diagram showing the AC peak current controller of the AC controller of FIG. 1, according to one illustrated exemplary implementation, drivingly coupled to the power converter of FIG. 2B.

FIG. 4 is a set of graphs representing a clock signal, a PWM signal, a voltage and a current occurring during a positive current cycle of control implemented by the AC controller of FIG. 1, according to one illustrated implementation.

FIG. 5 is a set of graphs representing a clock signal, a PWM signal, a voltage and a current occurring during a negative current cycle of control implemented by the AC controller of FIG. 1, according to one illustrated implementation.

FIG. 6 is a set of graphs sharing a time axis that shows a simulation of operation of the AC controller FIG. 1, the graphs representing measured phase currents for three phases of the electric machine, a back electromotive force including varied and significant harmonic content, and a resulting voltage applied to each of the three phases of the electric machine, according to one illustrated implementation.

FIG. 7 is a schematic diagram showing a method of operation of an exemplary implementation of the drive circuit of FIG. 1 including the AC controller, according to one illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with electric machines including electric motors, control systems including motor drivers, sensors, communications channels or buses (e.g., CAN bus), and/or other equipment have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

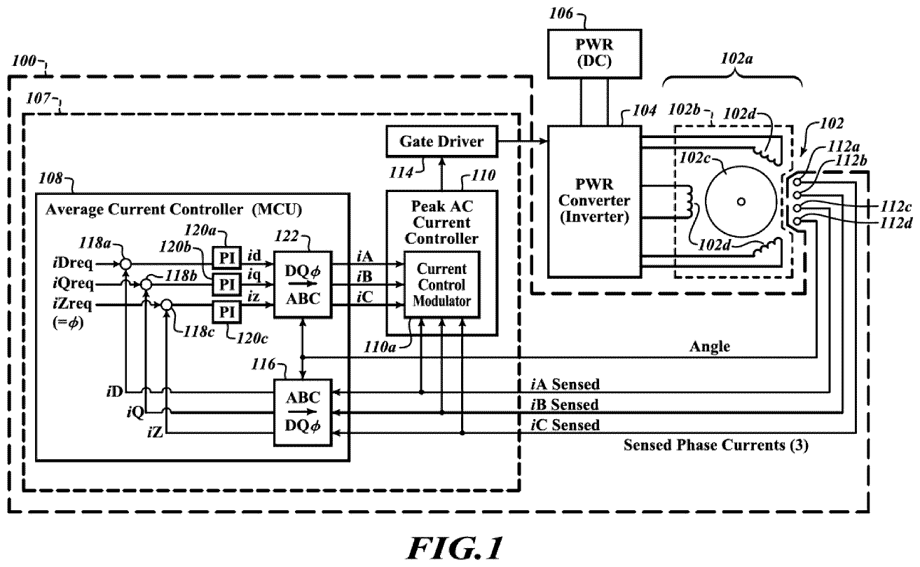

FIG. 1 is a schematic diagram showing a drive circuit 100 coupled control a power converter 104 which is in turn coupled to drive a rotating electric machine 102, the power converter 104 coupled to receive power from a power source 106, according to one illustrated implementation. In some implementations the drive circuit 100 can alternatively be referred to as an electric machine drive circuit where such is coupled to control a supply of current to an electric machine via the power converter 104.

The drive circuit 100 advantageously includes an alternating current (AC) controller 107 which itself includes an average current controller 108, and an alternating current (AC) peak current controller 110, as described herein. The drive circuit 100 optionally includes sensors 112a, 112b, 112c, 112d and optionally a gate driver 114, the operation of which are described below. While the power converter 104 is illustrated as a separate component from the drive circuit 100, in at least some implementations the power converter 104 can be supplied with or included as part of the drive circuit 100.

The rotating electric machine 102 can take any of a variety of forms, typically in the form of an electric motor 102a with a stator 102b and a rotor 102c, the rotor 102c rotatable with respect to the stator 102b. The electric motor 102a can likewise take any of a large variety of forms, for example a permanent magnet electric motor or a synchronous electric motor, an induction electric motor or asynchronous electric motor, or a reluctance electric motor. The stator 102b typically has windings or sets of windings for each phase, for example three windings or three sets of windings 102d for each of three phases. While the illustrated implementation is described with respect to a three phase system, the total number of phases and/or windings should not be considered limiting. Current driven through the windings 102d creates an electromotive force to cause the rotor 102c to rotate with respect to the stator 102b. Permanent magnet electric motors include permanent magnets arrayed about the rotor 102c. Alternatively, electromagnets can be arrayed about the rotor 102c. While described with respect to an electric machine, and in particular an electric motor, various implementations can be advantageously employed in other environments, for example employed with an electric generator or with an electric power grid or other power distribution network.

The power converter 104 can take a large variety of forms. The power converter 104 is electrically coupled to and operable to supply an alternating current (AC) to the windings or sets of windings 102d of the stator 102b. Where electrically coupled to a direct current (DC) power source 106 (e.g., DC link capacitors, chemical battery cells, fuel cells, super- or ultra-capacitors), the power converter 104 takes the form of, or is at least operable as, a power inverter, that inverts a DC power input to an AC power output, under control of the drive circuit 100, as described herein. In some implementations, the power converter 104 is also operable as a rectifier, rectifying an AC power input to a DC power output, for instance during a regenerative braking operation or mode. In some implementations, the power converter 104 is also operable as a DC-DC converter to step up or step down a DC voltage. The illustrated power converter 104 can, for example, take the form of a voltage source inverter VSI power stage comprising switches and a suitable DC power source (DC link capacitors, batteries, etc.).

The sensors 112a, 112b, 112c, 112d are referred to as optional to indicate that the sensors 112a, 112b, 112c, 112d can optionally form part of the drive circuit 100. Alternatively, the sensors 112a, 112b, 112c, 112d can be separate and distinct from the drive circuit 100, and can be communicatively coupled to provide signals to the drive circuit 100. In at least some implementations, there can be at least one sensor 112a, 112b, 112c for each phase. The sensors 112a, 112b, 112c (also interchangeably referred to as phase current sensors) are positioned to sense or measure a respective phase current for each phase of the electric motor 102a. In some implementations, this approach can avoid phase reconstruction (e.g., measuring only 2 of the 3 phases in a 3-phase system). While sensors 112a, 112b, 112c are illustrated grouped together in FIG. 1, each sensor 112a, 112b, 112c will typically be at least proximate a respective stator winding 102d or proximate a respective electrically conductive path leading to the respective stator winding 102d to sense a respective phase current. In at least some implementations, there can be one or more angle or rotation sensors 112d (e.g., Hall effect sensors, encoders, resolvers) that senses a rotation or an angle or rotational speed of the rotor 102c of the electric motor 102a. In some implementations, the rotor angle can be derived from other sensed quantities, such as phase currents and voltages, resulting in what could in some sense be termed a “sensor-less” algorithm.

The average current controller 108 takes the form of circuitry and/or executable instructions which implement logic to advantageously command an output current rather than a voltage based on a comparison of measured phase currents of the electric motor with respect to requested currents. The average current controller 108 can, for example, take the form of a microcontroller (MCU) or other type of hardware processor (e.g., microprocessor, central processing unit (CPU), digital signal processor (DSP), graphics processing unit (GPU), application specific integrated circuit (ASIC), field programmable gate array (FPGA), programmable logic controller (PLC), with or without memory), although other hardware implementations are possible.

The average current controller 108 can be implemented as an external or outer average current control loop. In the case of a three phase system this is elegantly handled by two proportional integral (PI) controllers nested between two transforms (e.g., direct-quadrature transforms, for instance in a three phase system a first direct-quadrature-zero transform (abc→DQ0) and a second direct-quadrature-zero transform (DQ0→abc), similar to FOC approaches. However, in the approach described herein, the average current controller 108 employs phase currents to advantageously produce reference currents instead of voltages. These reference currents are then provided as input to the AC peak current controller 110, as described below. The AC peak current controller 110 can be implemented as an internal or inner control loop. While the illustrated implementation is described with respect to first and second direct-quadrature-zero transforms in a three phase system, other transforms can be employed, for example with systems having more or less than three phases. Alternatively, the AC peak current controller 110 can be employed using FOC, for example in lieu of the average current controller 108.

The average current controller 108 receives signals indicative of the requested current (e.g., iD req, iQ req, iZ req, where iZ req is typically equal to zero). The signals indicative of the requested current (e.g., iD req, iQ req, iZ req) are supplied from any of a variety of sources, for example a throttle or processor associated with a throttle or other source of torque commands.

The average current controller 108 receives signals indicative of sensed or measured phase currents (iA sensed, iB sensed, iC sensed) of the electric motor 102a. The signals indicative of sensed or measured phase currents iA sensed, iB sensed, iC sensed of the electric motor 102a are supplied by phase current sensors 112a, 112b, 112c. The average current controller 108 can include or implement a first direct-quadrature-zero transform 116 (i.e., ABC→DQ0) that transforms the sensed or measured phase currents (e.g., supplied by sensors 112a, 112b, 112c) from a poly phase reference frame of the AC system to a rotational reference frame, using a sensed or derived angle from AC system. The first direct-quadrature-zero transform 116 can, for example, transform the received signals representative of the three sensed or measured phase currents to respective ones of a sensed direct current (iD), a sensed quadrature current (iQ) and a sensed zero current (iZ).

The average current controller 108 includes current comparators that are communicatively coupled and operable to compare requested current (also interchangeably referred to demanded current) against measured current. For example, the average current controller 108 can include a set of three comparators, difference or subtraction circuits 118a, 118b, 118c that finds the differences between the sensed direct current (iD), the sensed quadrature current (iQ) and the sensed zero current (iZ) and respective ones of the requested direct current (iD req), the requested quadrature current (iQ req) and the requested zero current (iZ req). The difference or subtraction circuits 118a, 118b, 118c supply the resulting difference to respective ones of three proportional integral (PI) controllers 120a, 120b, 120c of the average current controller 108.

The PI controllers 120a, 120b, 120c produce: a direct current (id) reference signal, a quadrature current (iq) reference signal and a zero current (iz) reference signal.

The average current controller 108 can include or implement a second direct-quadrature-zero transform 122 (i.e., DQ0→ABC) that transforms the reference currents from the rotational reference frame to the poly phase reference frame of the AC system, using a sensed or derived angle from AC system. Thus, the average current controller 108 can supply signals that advantageously represent commanded output current to the AC peak current controller 110.

The AC peak current controller 110 advantageously handles the positive and negative currents used with the AC current control.

The AC peak current controller 110 receives signals representing the sensed or measured phase current (iA sensed, iB sensed, iC sensed) for each phase of the electric motor 102a. For example, the AC peak current controller 110 is communicatively coupled to receive sensed or measures phase currents (iA sensed, iB sensed, iC sensed) from the sensors 112a, 112b, 112c (also interchangeably referred to as phase current sensors).

The AC peak current controller 110 receives signals representing the differences between the requested currents (iD req, iQ req, iZ req) and the sensed currents (iD, iQ) iZ). For example, the AC peak current controller 110 is communicatively coupled to receive signals that represent commanded output current from the second direct-quadrature-zero transform 122 (DQ0→ABC) of the average current controller 108. The AC peak current controller 110 determines a correct group of voltage vectors to apply. For example if the reference current is larger than the measured current, then a positive voltage vector is applied to regulate the current.

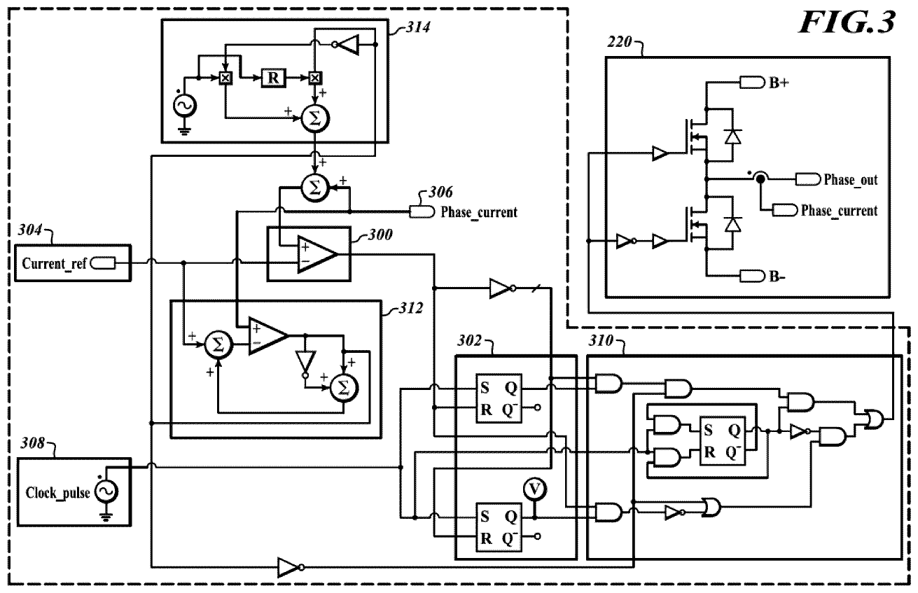

The AC peak current controller 110 immediately responds to changes in voltage, advantageously eliminating delays in response as well as voltage dependent gain variations. The AC peak current controller 110 can include a current control modulator 110a which is operable to modulate the duty cycle applied to the switching stage to regulate the current. The current control modulator 110a can take the form of dedicated circuitry (e.g., logic circuits) or processor-executable instructions executable by a processor (e.g., microcontroller, microprocessor, CPU, DSP, GPU, ASIC, FPGA, PLC, with or without memory) or a combination of circuitry and processor-executable instructions. Implementations of the AC peak current controller 110 are described in more detail below in reference to FIG. 3.

The gate driver 114 is referred to as optional to indicate that the gate driver 114 can optionally form part of the drive circuit 100 and/or optionally form part of the AC controller 107. Alternatively, the gate driver 114 can be separate and distinct from the drive circuit 100 and/or from the AC controller 107, and be communicatively coupled to receive signals from the circuit 100 and/or from the AC controller 107. The gate driver 114 is coupled to selectively apply control signals to the switches of the power converter 104, for example applying gate drive signals to gates of transistors (e.g., metal oxide semiconductor field effect transistors (MOSFETs), insulated gate bipolar transistors (IGBTs), bipolar junction transistors (BJTs), static induction transistors (SITs)). Such can, for example, control currents supplied or otherwise handled via the power converter 104.

While generally illustrated and described with respect to a drive circuit to drive a poly phase electric machine (e.g., three phase electric motor), those of ordinary skill in the art will appreciate that the AC controller 107 can be used to control a power converter for a large variety of applications, for example applications involving poly phase loads and/or sources. Those of ordinary skill in the art will also appreciate that in at least some implementations, the AC peak current controller 110 can advantageously be used without the average current controller 108 and/or without one or more other components or structures of the drive circuit 100.

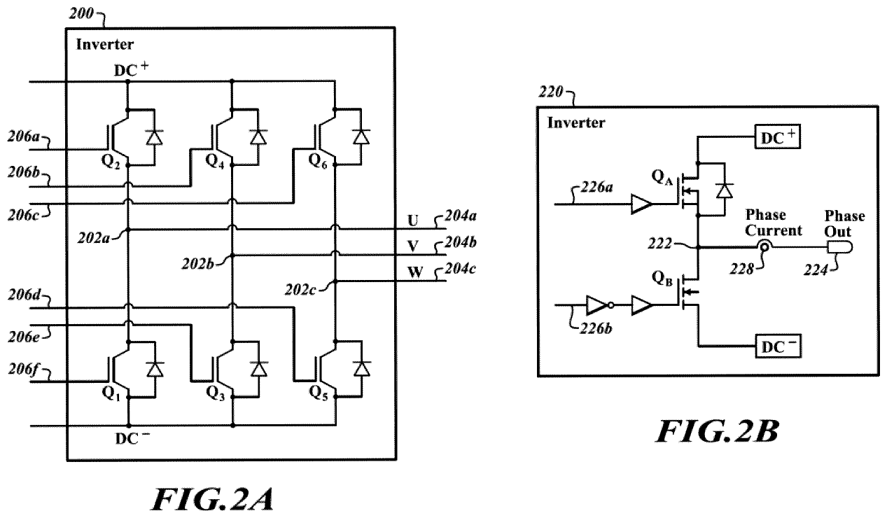

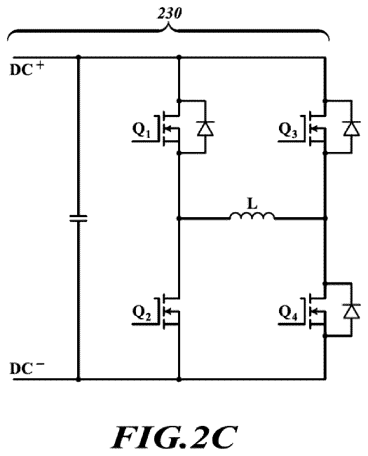

FIG. 2A shows a power converter 200 in the form of a three phase power converter according to one illustrated implementation, which can be electrically coupled and is operable to supply current to drive a rotating electric machine based on drive signals generated by the AC controller 107 of the drive circuit 100 of FIG. 1.

The power converter 200 includes a positive and negative DC voltage rails DC+, DC−, and a plurality of switches in the form of pairs of transistors Q₁ and Q₂, Q₃ and Q₄, Q₅ and Q₆, coupled between the DC voltage rails DC+, DC−, with a respective node 202a, 202b, 202c between each pair of transistors Q₁ and Q₂, Q₃ and Q₄, Q₅ and Q₆. The nodes provide currents U, V, W to the windings of the electric motor 102a (FIG. 1) via output lines 204a, 204b, 204c. A number of gate drive lines 206a, 206b, 206c, 206d, 206e, 206f allow gate drive signals to be applied to the transistors Q₁, Q₂, Q₃, Q₄, Q₅, Q₆, by the gate driver 114 (FIG. 1) in response to signals from the drive circuit 100.

FIG. 2B shows a power converter 220 in the form or arrangement of a half-bridge or single phase power converter according to one illustrated implementation. One or more instances n of the power converter 220 can be electrically coupled to and are operable to supply current to drive an n phase rotating electric machine based on drive signals generated by the AC controller 107 of the drive circuit 100 of FIG. 1. As noted, the power converter 220 can, for example, take the form of a half bridge power stage, as illustrated in FIG. 2B. There can be a respective power converter 220 for each phase of the electric machine, for instance three power converters 220 for a three phase electric motor.

The power converter 220 includes a positive and negative DC voltage rails DC+, DC−, and a pair of switches in the form of pairs of transistors QA and QB coupled between the DC voltage rails DC+, DC−, with a node 222 between the pair of transistors Q_{A}, Q_{B}. The node 222 provide a phase current to the winding of the electric motor 102a (FIG. 1) via output line 224. A number of gate drive lines 226a, 226b allow gate drive signals to be applied to the transistors Q_{A}, Q_{B}, by the gate driver 114 (FIG. 1) in response to signals from the electric machine drive circuit 100.

The power converter 220 can optionally include a phase current sensor 228 positioned and operable to sense or measure phase current, which can be used as a feedback signal by the drive circuit 100.

FIG. 2C shows a power converter 230 in the form of an H-bridge power stage coupled to an inductor L, according to one illustrated implementation. The inductor L can, for example, be a winding of a rotating electric machine in the form of a poly phase electric motor.

The power converter 230 includes pairs of switches Q₁, Q₂; and Q₃, Q₄, each pair of switches Q₁, Q₂; and Q₃, Q₄, coupled between a high side voltage rail or bus DC+ and a low side voltage rail or bus DC−. The pairs of switches Q₁, Q₂; and Q₃, Q₄, are operable, for example driven by pulse width modulated signals, to provide an AC current to the inductor L.

FIG. 3 shows one possible implementation of the AC peak current controller 110 of the AC controller 107 of the drive circuit 100 of FIG. 1 according to one illustrated implementation, drivingly coupled to the power converter 220 (i.e., half bridge power stage with phase current sensor) of FIG. 2B. One of skill in the art will appreciate that the AC peak current controller 110 can be implemented using other circuit topologies, or can even be implemented via executable instructions (e.g., stored as software or firmware) executing on one or more processors (e.g., microprocessors, micro-controllers, central processing units (CPUs), digital signal processors (DSPs), graphics processing units (GPUs), application specific integrated circuits (ASICs), field programmable gate arrays (FPGAs) and the like), particularly where such processors are sufficiently fast to achieve the desired level of responsiveness for control of the inverter for a given application (e.g., control of an electric motor).

The AC peak current controller 110 advantageously handles the positive and negative currents used with the AC current control. AC peak current controller 110, for example, determines a correct group of voltage vectors to apply. For instance, if a reference current is larger than a measured current, then the AC peak current controller 110 determines to apply a positive voltage vector to regulate the current, as described in more detail herein.

The AC peak current controller 110 determines whether a measured current has reached a same amplitude or magnitude as a target current. Thus, the AC peak current controller 110 can include a current comparator 300 that compares current reference input against phase current feedback. On determining that the measured current has reached the amplitude or magnitude of a target current the current comparator 300 can, for example generate a TRUE Boolean state that resets a control logic circuit (e.g., flip-flop or latch circuit 302) or flag accordingly. The current comparator 300 of the illustrated AC peak current controller 110 receives signals represented of a demanded current (e.g., iA, iB, iC from average current controller 108, FIG. 1) via a current demand input 304 and receives a signals representative of sensed or measured phase current(s) (e.g., sensed or measured phase current iA sensed, iB sensed, iC from phase current sensors 112a, 112b, 112c, FIG. 1) via a phase current input 306. The current comparator 300 compares the demanded current against the sensed or measured phase current, for example generating an OFF pulse once a target current is reached.

The illustrated AC peak current controller 110 includes a clock or clock signal generator 308 to generate the timing signals. The illustrated AC peak current controller 110 can use the clock signal to “set” a control logic circuit state (flip-flop or latch circuit 302), as well as control the state of a PWM state machine 310 (described below) which can implement a current control modulator 110a (FIG. 1). For example, the AC peak current controller 110 can include a flip flop or latch circuit 302 which receives the pulses of clock signal to turn a switch state ON and then OFF when the current comparator 300 changes state. The devices of the control flip-flop or latch circuit 302 are turned ON with a clock pulse on SET, and turned OFF when an output of the current comparator 300 changes states.

The illustrated AC peak current controller 110 determines whether a currently selected group or set of voltage vectors (e.g., positive and zero; or negative and zero) can control the phase current, thereby determining which voltage polarity is to be employed at a given time to regulate an output current. In at least one exemplary illustrated implementation, the AC peak current controller 110 includes a polarity detector 312 that detects polarity, polarity detector 312 comprising of a comparator or similar circuit which compares the target current against the measured current, and for example determines which of two vectors (e.g., 1/0 or −1/0) are to be used to control the current. For instance, if the sensed or measured phase current is less than the reference current, then a positive and zero vector (i.e., 1/0) is selected. For instance, if the sensed or measured phase current is greater than the reference current, then a negative and zero vector (i.e., −1/0) is selected. In at least some implementations, the polarity detector 312 can have an associated hysteresis, which can be an adjustable variable, to achieve a desired or specified level of responsiveness and thereby prevent unintentional undesired rapid switching.

The state machine 310 of the illustrated AC peak current controller 110, or other implementation of similar logic, takes the generated pulse from the control flip-flop or latch circuit 302, the polarity detector and the clock or clock signal generator 308 (e.g., system clock) to generate the correct PWM pattern. The state machine 310 can include a plurality of logic circuits and flip-flops or latch circuits, communicatively coupled to generate the switching pattern for the PWM driven bridges of the particular power converter 200 (FIG. 2A), 220 (FIG. 2B), 230 (FIG. 2C). In another exemplary implementation, the AC peak current controller 110 can employ processor-executable instructions (e.g., stored as software or firmware) executing on one or more processors to generate the correct PWM pattern.

The illustrated AC peak current controller 110 optionally includes a ramp generator 314, which can be used to provide ramp compensation for certain loads, adding output to the phase current feedback. In the illustrated implementation, the amplitude of the ramp is adjustable from zero to a preset maximum. The ramp generator 314 can be inverted or non-inverted based on an output of the polarity detector 312 for correct operation.

While one implementation of an AC peak current controller modulator is illustrated, it is noted that an AC peak current controller modulator can operate with common 3 phase motor drive topologies using 3 half bridges, or can generate a unipolar PWM pattern for H bridge based single phase inverters, or a single AC peak current controller modulator can be used on a simple half bridge split rail inverter.

As previously noted, those of ordinary skill in the art will also appreciate that in at least some implementations, the AC peak current controller 110 can advantageously be used without the average current controller 108 and/or without one or more other components or structures of the drive circuit 100.

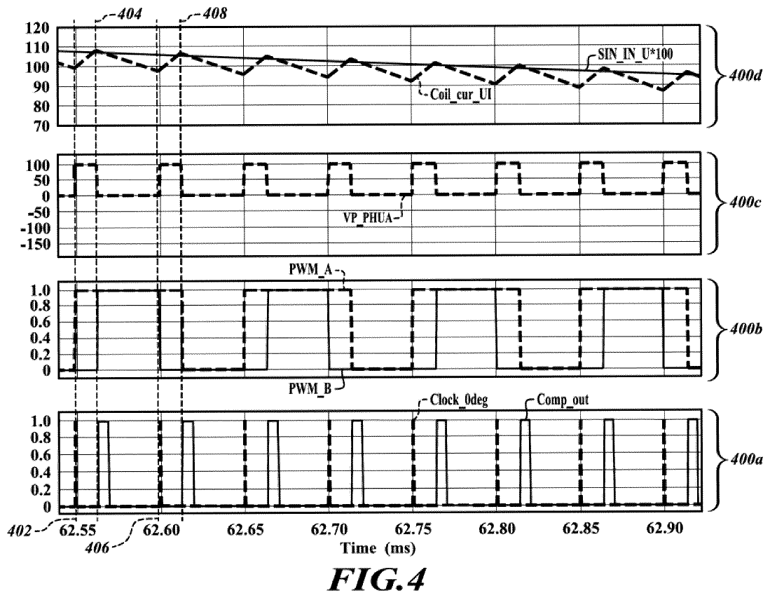

FIG. 4 is a set of graphs 400a, 400b, 400c, 400d representing a positive current cycle of control implemented by the AC controller 107 of the drive circuit 100 (FIG. 1), according to one illustrated implementation, including a sequence of events in regulating positive current.

In particular, FIG. 4 shows a clock signal over time (Clock_Odeg) generated, for example, by the clock or clock signal generator 308 (FIG. 3). FIG. 4 also shows a current comparator output signal over time (Comp_out) generated, for example, by the current comparator 300 (FIG. 3).

FIG. 4 further shows a PWM_A signal and PWM_B signal over time, for example generated by state machine 310 (FIG. 3). In the illustrated implementation, the PWM_A signal is the state signal applied to one side of an H-bridge circuit of the power converter and the PWM_B signal is the state signal applied to other side of the H-bridge circuit of the power converter. In this example, a value 1 represents a high side of the corresponding half bridge circuit ON and a low side of the corresponding half bridge circuit is OFF, while a value 0 represents a high side of the corresponding half bridge circuit OFF and the low side of the corresponding half bridge circuit is ON.

FIG. 4 also shows a voltage (VP_PHUA) over time that is applied to a load (e.g., coil or winding of an electric machine).

FIG. 4 additionally shows a regulation current target over time (SIN_IN_U*100) and a sensed or measured coil current over time (Coil_cur_U1).

At 402, a clock pulse triggers a turn ON event. The turn ON event results in PWM_A signal changing state to 1, and applying a vector (+ve) to the load. In this example, +100 V (VP_PHUA) is applied to the load.

At 404, when a current target is reached (SIN_IN_U), the current comparator (COMP_OUT) goes HIGH, and the state machine changes PWM_B signal state to 1, resulting in 0V being applied to the load.

At 406, a clock pulse triggers the next turn ON event again, and in response the PWM_B changes back to 0 applying a positive vector to the load. In this example a +100V is applied to the load.

At 408, when a current reaches the regulation target (SIN_IN_U) and the current comparator changes state, the PWM_A signal changes state to 0, and 0V is applied to the load.

The above acts complete one cycle in the state machine 310 (FIG. 3) when the polarity detector 312 is commanding a positive and zero vector (+1, 0) be applied.

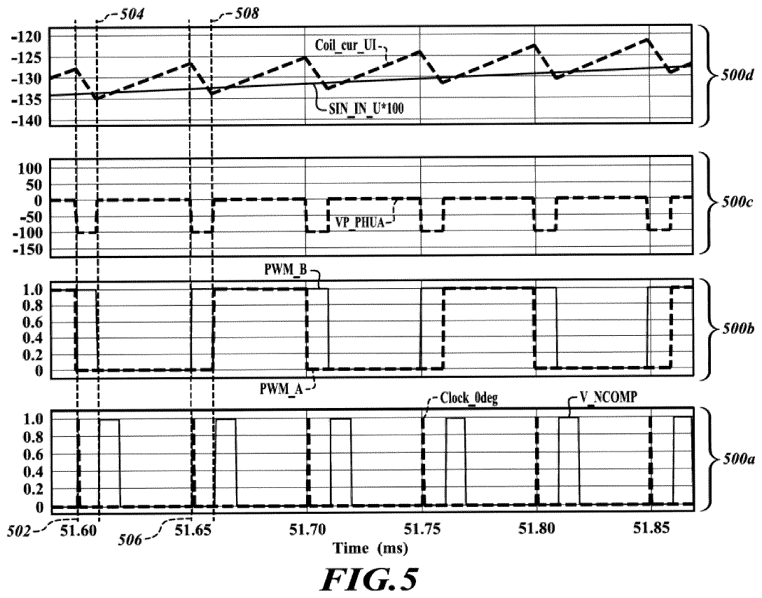

FIG. 5 is a set of graphs 500a, 500b, 500c, 500d representing a negative current cycle of control implemented by the AC controller 107 of the drive circuit 100 (FIG. 1), according to one illustrated implementation, including a sequence of events in regulating negative current.

In particular, FIG. 5 shows a clock signal over time (Clock_Odeg) generated, for example, by the clock or clock signal generator 308 (FIG. 3). FIG. 4 also shows a current comparator output signal over time (V_NComp) generated, for example, by the current comparator 300 (FIG. 3).

FIG. 5 further shows a PWM_A signal and PWM_B signal over time, for example generated by state machine 310 (FIG. 3). In the illustrated implementation, the PWM_A signal is the state signal applied to one side of an H-bridge circuit of the power converter and the PWM_B signal is the state signal applied to other side of the H-bridge circuit of the power converter. In this example, a value 1 represents a high side of the corresponding half bridge circuit ON and the low side of the corresponding half bridge circuit is OFF, while a value 0 represents a high side of the corresponding half bridge circuit OFF and the low side of the corresponding half bridge circuit is ON.

FIG. 5 also shows a voltage (VP_PHUA) over time that is applied to a load (e.g., coil or winding of an electric machine).

FIG. 5 additionally shows a regulation current target over time (SIN_IN_U*100) and a sensed or measured coil current over time (Coil_cur_U1).

At 502, a clock pulse triggers a turn ON event. The turn ON event results in PWM_A signal changing state to 1, and applying a vector (−ve) to the load. In this example, −100 V (VP_PHUA) is applied to the load.

At 504, when a current target is reached (SIN_IN_U), the current comparator (COMP_OUT) goes HIGH, and the state machine changes PWM_B signal state to 1, resulting in 0V being applied to the load.

At 506, a clock pulse triggers the next turn ON event again, and in response the PWM_B changes back to 0 applying a negative vector to the load. In this example a-100V is applied to the load.

At 508, when a current reaches the regulation target (SIN_IN_U) and the current comparator changes state, the PWM_A signal changes state to 0, and 0V is applied to the load.

The above acts complete one cycle in the state machine 310 (FIG. 3) when the polarity detector 312 is commanding a negative and zero vector (−1, 0) be applied.

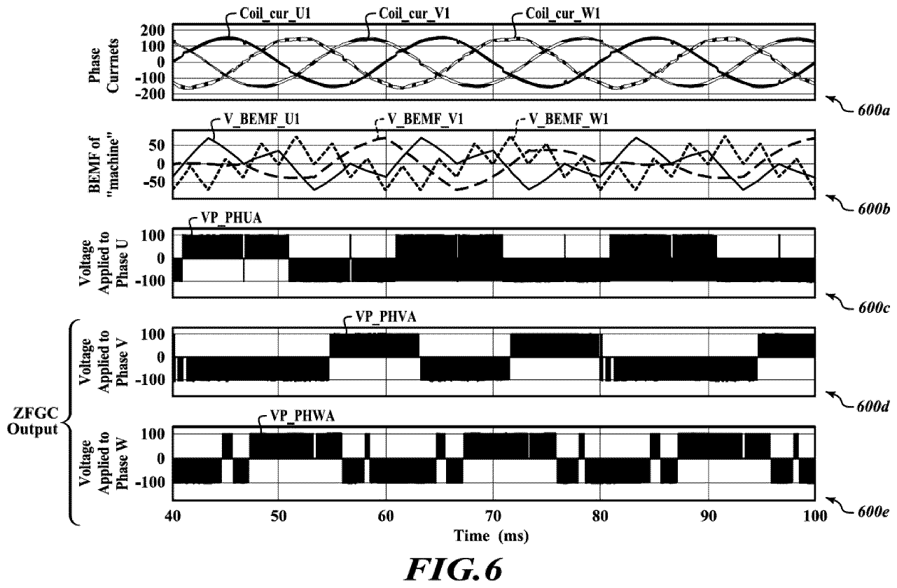

FIG. 6 is a set of graphs 600a, 600b, 600c, 600d, 600f sharing a time axis that shows a simulation of operation of a drive circuit, according to one illustrated implementation. This simulation shows the drive circuit 100 responding to different and bad harmonic back electromotive force.

In particular, FIG. 6 shows a respective sensed or measured phase current (Coil_cur_U1, Coil_cur_V1, Coil_cur_W1) for each of three phases of the electric machine over a period of time.

FIG. 6 also shows a respective back electromotive force voltage (V_BEMF_U1, V_BEMF_V1, V_BEMF_W1) for the three phases of the electric machine over the period of time.

FIG. 6 further shows voltages (VP_PHUS, VP_PHVA, VP_PHWA) applied to each phase of the electric machine over the period of time.

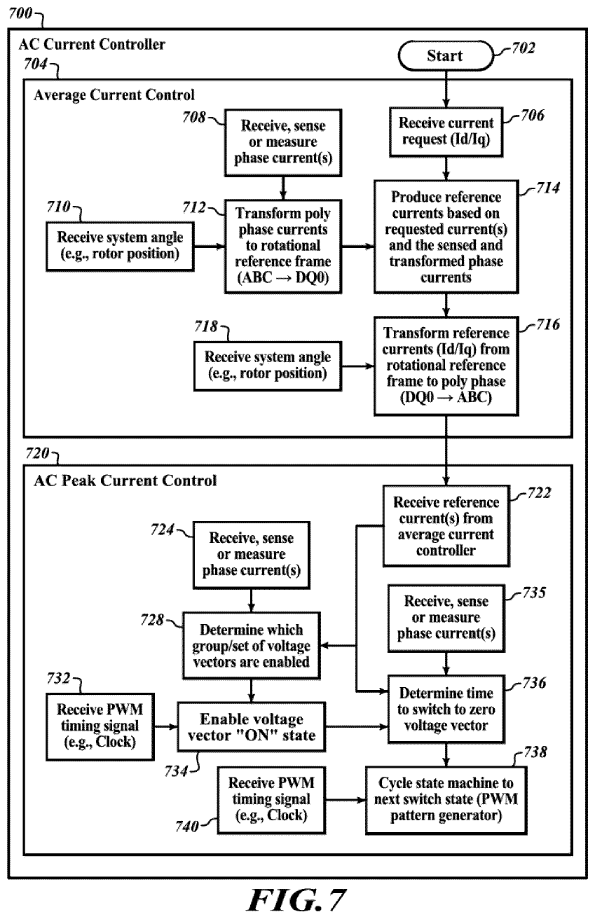

FIG. 7 shows an AC current controller 700 of the drive circuit 100 (FIG. 1) executing a method of operation to control an inverter and an electric machine (e.g., electric motor), according to one illustrated implementation.

The method starts at 702, for example when called or invoked by a calling routine or upon a powering ON of a system (e.g., motor control system, inverter, electric motor drive).

At 706, an average current controller 704 of the AC current controller 700 receives signals representative of requested currents. Such signals can come from any of a variety of sources, for instance from a throttle.

At 708, one or more sensors receive, sense and/or measure one or more phase currents of a rotating electric machine. As previously noted, in some implementations a rotor angle can be sensed directly via rotor angle sensors (e.g., rotor angle encoders) or derived from other sensed quantities, such as derived from sensed phase currents and/or voltages.

At 710, the average current controller 704 of the AC current controller 700 receives signals representative of the sensed or calculated AC system angle, for example from an angle sensor on a rotor of an electric machine or from a phase locked loop system that synchronizes with an external AC system for example an electricity grid to name only a few sources of such signals.

At 712, a controller or transform of the average current controller 704 of the AC current controller 700 transforms the sensed phase currents from a poly phase reference frame to a rotational reference frame using the system angle, for example via a first transform, that is an ABC to direct-quadrature-zero transform (ABC→DQ0).

At 714, the average current controller 704 of the AC current controller 700 produces reference currents based on the received signals representative of requested currents and on signals representative of the sensed or measured phase currents. For example, the average current controller 704 can subtract the measured direct current (iD), the measured quadrature current (iQ) and the measured zero current (iZ) from respective ones of the requested direct current (iD req), the requested quadrature current (iQ req) and the requested zero current (iZ req) from the first transform via a number of subtraction circuits, generating an error for all the respective requested quantities. In some implementations the zero portion of the transformation maybe ignored. Also for example, the average current controller 704 can provide resulting sums to respective PI controllers.

At 716, a controller or transform of the average current controller 704 of the AC current controller 700 transforms the reference currents, using the AC system angle 718, from the rotational reference frame to the poly phase reference frame of the AC system, for example via a second transform, that is a direct-quadrature-zero to ABC transform (DQ0→ABC).

At 722, an alternating current (AC) peak current controller 720 receives the reference currents from the average current controller 704, for example via the second transform (i.e., direct-quadrature-zero to ABC transform).

At 724, one or more sensors receive, sense and/or measure one or more phase currents of a rotating electric machine.

At 728, an AC peak current controller 720 determines which group of voltage vectors to apply or enabled based on the AC system phase currents and the reference currents. For example if the reference current is larger than the measured current then the positive voltage vector must be applied to regulate the current.

At 732, an AC peak current controller 720 receives a PWM timing signal, for example from a system PWM clock and the demanded voltage vector from 728.

At 734, the AC peak current controller 720 enables the application of the positive voltage vector of the drive circuit.

At 735, one or more sensors receive, sense and/or measure one or more phase currents of a rotating electric machine. As previously noted, in some implementations a rotor angle can be sensed directly via rotor angle sensors (e.g., rotor angle encoders) or derived from other sensed quantities, such as derived from sensed phase currents and/or voltages.

At 736, an AC peak current controller 720 determines a correct time to apply the zero vector. For example, the AC peak current controller 720 can monitor the received or measured phase current(s) at 735, comparing those currents against the reference currents received at 722.

At 738, an AC peak current controller 720 generate the appropriate PWM pattern. The AC peak current controller 720 can, for example, include or implement a state machine or similar structure or instructions, to cycle a power conversion bridge, through the correct combination of switch states to generate the appropriate PWM pattern. The PWM pattern can, for example, take the form of the commonly utilized unipolar PWM. Such a state machine, utilizing the PWM timing signal, generates the switch drive signals. Such can include generating PWM signals (e.g., PWM_A, PWM_B) such as illustrated in FIGS. 4 and 5. As noted elsewhere, those of ordinary skill in the art will understand that other implementations can use approaches other than a state machine to generate the PWM pattern.

At 738, the AC peak current controller 720 supplies the generated drive signals to control a switching stage to provide control mode operation of the AC system, and hence to control operation of any attached rotating electric machine (e.g., electric motor). The AC peak current controller 720 can, for example, supply the generated drive signals to a gate drive, to generate gate drive signals which are applied to the switches of a power converter to provide current, for example to power an electric motor.

The above described method can be terminated at any time during operation, for example due to a system error or the inverter system becoming disabled or otherwise powered OFF. Alternatively, the method can repeat while the system is operational or powered ON.

It should be apparent that the above described method can include additional acts, omit some acts, and, or execute acts in a different order.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various implementations described above can be combined to provide further implementations. To the extent that they are not inconsistent with the specific teachings and definitions herein, all of the U.S. patents, U.S. patent application publications, U.S. patent applications, foreign patents, foreign patent applications and non-patent publications referred to in this specification, including: U.S. Application Ser. No. 63/290,712; International (PCT) Application Serial No. PCT/CA2022/000039; International (PCT) Application Serial No. PCT/CA2022/050753; and International (PCT) Application Serial No. PCT/CA2020/050534 (published as WO 2020/215154); International (PCT) Application Serial No. PCT/CA2019/051238 (published as WO 2020/047663); International (PCT) Application Serial No. PCT/CA2019/051239 (published as WO 2020/047664); International (PCT) Application Serial No. PCT/CA2018/050222 (published as WO 2018/213919); and U.S. Application Ser. No. 63/429,048, are incorporated herein by reference, in their entirety. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method of operation in alternating current (AC) controller, comprising:
receiving signals representative of requested currents by an average current controller;
receiving signals representative of phase currents by the average current controller;
producing reference currents by the average current controller based on the signals representative of requested currents and on the signals representative of the phase currents; and
receiving the reference currents from the average current controller by an alternating current (AC) peak current controller;
generating drive signals by the alternating current (AC) peak current controller based on the received reference currents; and
supplying the generated drive signals to control a switching stage.

2. The method of claim 1, further comprising:
transforming via a first transform the phase currents from a poly phase reference frame to a rotational reference frame; and
transforming via a second transform the reference currents from the rotational reference frame to the poly phase reference frame.

3. The method of claim 1, further comprising:
transforming via a first direct-quadrature-zero transform the phase currents from a poly phase reference frame to a rotational reference frame; and
transforming via a second direct-quadrature-zero transform the reference currents from the rotational reference frame to the poly phase reference frame.

4. The method of claim 3 wherein transforming via a first transform includes transforming the received signals representative of at least two phase currents to a sensed direct current (iD) and a sensed quadrature current (iQ).

5. The method of claim 4 and further comprising:
respectively providing by at least two proportional integral (PI) controllers: a direct current (id) reference signal and a quadrature current (iq) reference signal, to the first direct-quadrature-zero transform.

6. The method of claim 5 wherein receiving signals representative of requested currents includes receiving signals in a form of at least a requested direct current (iD req) and a requested quadrature current (iQ req).

7. The method of claim 6, further comprising:
determining a difference, via a number of circuits, between at least the sensed direct current (iD) and the sensed quadrature current (iQ) from the first direct-quadrature-zero transform and respective ones of the requested direct current (iD req) and the requested quadrature current (iQ req), and providing any resulting differences to respective ones of the PI controllers.

8. The method of claim 3 wherein transforming via a first transform includes transforming the received signals representative of at least two phase currents to a sensed direct current (iD) and a sensed quadrature current (iQ) and a sensed zero current (iZ), and respectively providing by at least two three proportional integral (PI) controllers: a direct current (id) reference signal, a quadrature current (iq) reference signal and a zero current (iz) reference signal, to the first direct-quadrature-zero transform.

9. The method of claim 1 wherein generating drive signals includes generating pulse width modulated (PWM) signals and supplying the generated drive signals to control a switching stage includes supplying the generated drive signals to a gate drive circuit, and further comprising:
applying a set of gate drive signals from the gate drive circuit to a plurality of switches of a power converter of the switching stage to invert a DC input to an AC output to provide control mode operation of a rotating electric machine.

10. The method of claim 9, further comprising:
comparing, by a current comparator, the reference currents received from the average current controller with the phase currents sensed by a number of phase current sensors; and
setting a control flip-flop circuit based on a result of a comparison by the current comparator.

11. The method of claim 10, further comprising:
detecting, by a polarity detector, a polarity which determines a vector to apply based on whether the phase currents are less than or greater than the requested currents;
generating a ramp current by a ramp generator, and
selectively adding an inverted or a non-inverted ramp current to the phase currents where an inverted or a non-inverted state is controlled by an output of the polarity detector.

12. (canceled)

13. An alternating current (AC) controller, comprising:
a number of phase current sensors operable to sense phase currents;
an average current controller communicatively coupled to receive signals representative of requested currents and communicatively coupled to receive signals representative of the phase currents sensed by the phase current sensors, and which produces a number of reference currents; and
an alternating current (AC) peak current controller communicatively coupled to receive the reference currents from the average current controller and which generates drive signals based on the received reference currents to control a switching stage.

14. The AC controller of claim 13 wherein the AC controller implements a first transform that transforms the sensed phase currents from a poly phase reference frame to a rotational reference frame and implements a second transform that transforms the reference currents from the rotational reference frame to the poly phase reference frame.

15. The AC controller of claim 13 wherein the AC controller implements a first direct-quadrature-zero transform that transforms the sensed phase currents from a poly phase reference frame to a rotational reference frame and implements a second direct-quadrature-zero transform that transforms the reference currents from the rotational reference frame to the poly phase reference frame.

16. The AC controller of claim 15 wherein the average current controller is communicatively coupled to receive signals representative of at least two phase currents sensed by the phase current sensors and the first direct-quadrature-zero transform transforms the received signals representative of the at least two phase currents to at least a sensed direct current (iD) and a sensed quadrature current (iQ).

17. (canceled)

18. (canceled)

19. The AC controller of claim 16 wherein the average current controller comprises at least two proportional integral (PI) controllers communicatively coupled to respectively provide at least a direct current (id) reference signal and a quadrature current (iq) reference signal to the first direct-quadrature-zero transform, wherein the average current controller is communicatively coupled to receive signals representative of requested currents in a form of at least a requested direct current (iD req) and a requested quadrature current (iQ req), and wherein the average current controller includes a number of comparators that determine a difference between at least the sensed direct current (iD) and the sensed quadrature current (iQ) from the first transform and respective ones of the requested direct current (iD req) and the requested quadrature current (iQ req), and that are communicatively coupled to provide resulting differences to respective ones of the PI controllers.

20. The AC controller of claim 15 wherein the average current controller is communicatively coupled to receive signals representative of at least three phase currents sensed by the phase current sensors and the first direct-quadrature-zero transform transforms the received signals representative of the at least three phase currents to at least a sensed direct current (iD), a sensed quadrature current (iQ), and a sensed zero current (iZ), wherein the average current controller comprises at least three proportional integral (PI) controllers communicatively coupled to respectively provide at least a direct current (id) reference signal, a quadrature current (iq) reference signal, and a zero current (iz) reference signal to the first direct-quadrature-zero transform, wherein the average current controller is communicatively coupled to receive signals representative of requested currents in a form of at least a requested direct current (iD req), a requested quadrature current (iQ req), and a requested zero current (iZ req), where the requested zero current (iZ req) is set to zero, and wherein the average current controller includes a number of comparators that determine a difference between at least the sensed direct current (iD), the sensed quadrature current (iQ) and the sensed zero current (iZ) from the first transform and respective ones of the requested direct current (iD req), the requested quadrature current (iQ req) and the requested zero current (iZ req), and that are communicatively coupled to provide resulting differences to respective ones of the PI controllers.

21.-24. (canceled)

25. The AC controller of claim 13 wherein the average current controller is implement as an outer control loop and the AC peak current controller is implemented as an inner control loop.

26.-27. (canceled)

28. The AC controller of claim 13 wherein the switches of the switching stage comprises an arrangement of three half bridges.

29.-30. (canceled)

31. A method of operation in a control system comprising an alternating current (AC) peak current controller, the method comprising:
receiving signals representative of a set of phase currents by the AC peak current controller;
receiving signals representative of a set of requested currents by the AC peak current controller;
comparing the phase currents with the requested currents;
determining a voltage vector to apply based on a comparison of the phase currents with the requested currents;
enabling a state of the determined voltage vector based at least in part on a pulse width modulated (PWM) timing signal; and
generating a PWM switching pattern based at least in part on the state of the determined voltage vector.

32.-40. (canceled)
